(19) United States
(12) Patent Application Publication
(10) Pub. No.: US 2026/0295902 A1
(43) Pub. Date: Oct. 1, 2026

(54) SYSTEMS AND METHODS OF MANUFACTURING A BIODEGRADABLE COMPOSITE MATERIAL

(71) Applicant: Mohamed Ziyan Mujeem, Western (LK)

(72) Inventor: Mohamed Ziyan Mujeem, Western (LK)

(21) Appl. No.: 19/094,402

(22) Filed: Mar. 28, 2025

(51) Int. Cl. B29B 7/72; B29B 7/60; B29B 7/82; B29B 15/08; B29K 67/00; B29K 511/10

(52) U.S. Cl. CPC B29B 7/726; B29B 7/603; B29B 7/823; B29B 7/826; B29B 15/08; B29K 2067/046; B29K 2511/10; B29K 2995/006

(57) ABSTRACT

The present disclosure provides a method of manufacturing a biodegradable composite material. Further, the method of manufacturing a biodegradable composite material may include blending, using a blending device, the rice husk with the biodegradable polymer in a particular range of a weight percentage to form a blended material. Further, the weight percentage of the rice husk may be in a range of a thirty percentage to a fifty percentage. Further, the weight percentage of the biodegradable polymer may be in a range of a fifty percentage to a seventy percentage.

### FIELD OF DISCLOSURE

The present disclosure generally relates to manufacturing biodegradable material. More specifically, the present invention is systems and methods of manufacturing a biodegradable composite material.

### BACKGROUND

Existing techniques of manufacturing a biodegradable composite material are deficient in several ways. This existing techniques needs manual operations to control and analyze a material in each stage of manufacturing. Further, it needs human evaluation to evaluate the quality of the material. Further, the existing biodegradable materials are limited in a range of applications and properties.

Therefore, there is a need for systems and methods of manufacturing a biodegradable composite material that may overcome one or more of the above-mentioned problems and/or limitations.

### SUMMARY OF DISCLOSURE

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present disclosure provides a method of manufacturing a biodegradable composite material. Further, the method of manufacturing a biodegradable composite material may include blending, using a blending device, a rice husk with a biodegradable polymer in a particular range of a weight percentage to form a blended material. Further, the weight percentage of the rice husk may be in a range of a thirty percentage to a fifty percentage. Further, the weight percentage of the biodegradable polymer may be in a range of a fifty percentage to a seventy percentage.

A system for manufacturing a biodegradable composite material, the system comprising a blending device which may be configured for blending a rice husk with a biodegradable polymer in a particular range of a weight percentage to form a blended material. Further, the weight percentage of the rice husk may be in a range of a thirty percentage to a fifty percentage. Further, the weight percentage of the biodegradable polymer may be in a range of a fifty percentage to a seventy percentage.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTIONS OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform 100 consistent with various embodiments of the present disclosure.

FIG. 2 is a block diagram of a computing device 200 for implementing the methods disclosed herein, in accordance with some embodiments.

FIG. 3 illustrates a flowchart of a method 300 of manufacturing a biodegradable composite material including shaping, using a shaping device 906, the blended material to a shape, in accordance with some embodiments.

FIG. 4 illustrates a flowchart of a method 400 of manufacturing a biodegradable composite material including generating, using the processing device 1004, a composition data, in accordance with some embodiments.

FIG. 5 illustrates a flowchart of a method 500 of manufacturing a biodegradable composite material including generating, using the processing device 1004, a command data, in accordance with some embodiments.

FIG. 6 illustrates a flowchart of a method 600 of manufacturing a biodegradable composite material including generating, using the processing device 1004, a biodegradability data, in accordance with some embodiments.

FIG. 7 illustrates a flowchart of a method 700 of manufacturing a biodegradable composite material including generating, using the processing device 1004, a quality data, in accordance with some embodiments.

FIG. 8 illustrates a block diagram of the system 800 of manufacturing a biodegradable composite material, in accordance with some embodiments.

### DETAILED DESCRIPTION OF DISCLOSURE

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data there between corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview

The present disclosure focuses on a novel biodegradable composite material made from rice husks, biodegradable polymers, and eco-friendly additives. This innovative composite targets diverse industries, including automotive, pharmaceuticals, agriculture, packaging, electronics, fashion, and rapid prototyping. By leveraging advanced AI-driven manufacturing processes, the methods and systems disclosed may ensure consistent quality, efficiency, and scalability while minimizing environmental impact.

The present disclosure encompasses the following key features:
1. Base Composition: The base composition of the composite material is a blend of rice husks (30% to 50% by weight) and biodegradable polymers (50% to 70%) enhanced with industry-specific additives.
2. AI-Driven Manufacturing: The integration of AI optimizes every stage, from material preparation to quality control, ensuring consistent quality, efficiency, and scalability while minimizing environmental impact.
3. Environmental Sustainability: The composite material is fully biodegradable, reducing reliance on petroleum-based materials and aligning with circular economy principles

The following are the formulation details encompassed by the present disclosure:
1. Primary Formula:
   Rice Husk: 30%-50% (by weight)
   Biodegradable Polymer: 50%-70% (by weight)
   Additives (optional):
   Natural Fibers: Coconut husk, banana fiber, kenaf, or flax
   Plasticizers: Glycerol, soybean oil for flexibility
   Binding Agents: Starch or plant-based resins
   UV Stabilizers: For outdoor applications
   Antimicrobial Agents: For sterile medical applications
2. Sample Formulations:
High-Strength Applications:
   Rice Husk: 40%, PLA: 60%, with natural fibers for durability.
   Target Industries: Automotive and durable packaging.
Flexible and Disposable Products:
   Rice Husk: 30%, PBS: 70%, with glycerol for flexibility.
   Target Industries: Medical devices and single-use items. p1 Soil-compatible Agriculture Products:
   Rice Husk: 50%, PHA: 50%, with bio char.
   Target Products: Seedling trays and mulch films.
Enhanced Biodegradability:
   Rice Husk: 35%, Polymer Blend (PLA+PBS): 65%, algae powder.
   Target Products: Eco-friendly packaging.
Prototyping and Custom Parts:
   Rice Husk: 40%, Polymer Blend (PLA+PHA): 60%, starch.
   Target Products: 3D printing filaments and rapid prototypes.

The present disclosure encompasses an AI driven manufacturing process, the integration of AI represents a breakthrough in material science, refining each stage of manufacturing for precision, efficiency, and adaptability.
1. Rice Husk Preparation: AI ensures uniform cleaning, sorting, and particle consistency:
   Imaging & Spectroscopy Analysis: AI identifies properties like moisture content and fiber strength.
   Dynamic Sorting: Neural networks automate separation for optimized compatibility with polymers.
2. Composite Mixing: AI models optimize blending parameters such as temperature, viscosity, and density:
   Sensor-Driven Inputs: Real-time monitoring adjusts the blend ratio for consistent material properties.
   AI-Powered Predictions: Historical and live data guide adjustments to ensure homogeneity and application-specific standards.
3. Heat Processing: Precision heat processing ensures optimal composite strength and flexibility:
   AI Predictive Models: Trained on thermal profiles, these models regulate heat cycles in real time to minimize energy use and maximize quality.
4. Adaptive Shaping and Molding: Advanced AI-guided systems enhance molding techniques:
   Injection Molding: AI predicts shrinkage and adjusts parameters for high-precision products.
   Compression Molding: Suitable for durable items like automotive panels.
   3D Printing: Reinforcement learning optimizes extrusion speed and layer consistency.
5. Continuous Quality Monitoring: AI continuously ensures product quality:
   Deep Learning Models: Detect micro-defects using imaging and ultrasonic sensors.
   Predictive Maintenance: AI flags potential equipment issues, reducing downtime and waste.
6. Biodegradability Control: AI customizes degradation profiles based on environmental conditions:
   Environmental Modeling: Simulations predict composite breakdown under various humidity and temperature levels.
   Formula Adjustments: AI tailors' formulations to meet biodegradability requirements for specific industries.

The following are the applications of biodegradable composite material:
1. Automotive Industry:
   Applications: Interior trims, sound-absorbing panels, fasteners.
   Formula: High-strength Formula A, enhanced with fibers for durability.
2. Pharmaceuticals and Medical:
   Applications: Disposable syringes, dosage cups, sterile packaging.
   Formula: Flexible Formula B with antimicrobial agents.
3. Agriculture:
   Applications: Biodegradable seedling trays, mulch films.
   Formula: Soil-compatible Formula C with bio char.
4. Packaging:
   Applications: Single-use containers, eco-friendly wraps.
   Formula: Flexible Formula D, optimized for rapid degradation.
5. Rapid Prototyping:
   Applications: Automotive prototypes, 3D-printed medical tools.
   Formula: Formula E with AI-enhanced extrusion consistency.

The following are the key advantages of the methods and systems:
Scalability and Precision: AI ensures uniformity across production.
Sustainability: This biodegradable composite material reduces reliance on petrochemical materials.
Predictive Capabilities: Proactive adjustments may ensure high-quality outputs.
Customizability: Tailored formulations can meet diverse industry needs.

The present disclosure encompasses the following key features:
AI-Controlled Biodegradability Adjustments (AI actively modifies material properties instead of just predicting)
AI-Optimized 3D Printing & Molding (Real-time defect correction & process adjustments)
AI-Guided Material Strength Optimization (Dynamic fiber dispersion & polymer bonding adjustments)
AI-Powered Environmental Adaptability (AI selects and customizes polymer blends based on external conditions)
AI-Driven Material Selection & Customization (Material formulation dynamically adjusts based on intended application)

The following are detailed description of each key feature:
1. AI-Controlled Biodegradability Adjustments
   In addition to AI predicting and tracking biodegradability and recyclability for waste management, AI actively adjusts the composition based on real-time environmental feedback.
   AI should not only predict degradation but also modify polymer crosslinking and additive levels dynamically. Further, AI adjusts plasticizer content, bio char levels, or stabilizers to fine-tune degradation speed based on industry needs.
   “An AI-driven biodegradability adaptation system that continuously modifies polymer composition and additive levels based on environmental sensor feedback, ensuring optimized degradation tailored for specific applications.”
2. AI-Optimized 3D Printing & Molding
   In addition to AI improving extrusion consistency, AI performs real-time defect correction during 3D printing or molding.
   AI should monitor and detect real-time defects using ultrasonic and optical sensors.
   The system should dynamically adjust extrusion speed, temperature, and cooling rates to correct errors as they occur rather than after production.
   Introduce adaptive shrinkage compensation for injection molding based on AI-predicted deformation patterns.
   “An AI-controlled shaping and defect correction system that dynamically adjusts process parameters based on real-time defect detection using ultrasonic and optical sensors, ensuring high-precision manufacturing of biodegradable materials.”
3. AI-Guided Material Strength Optimization
   In addition to monitoring mechanical strength, AI modifies fiber adhesion or polymer bonding dynamically.
   AI should analyze stress and compression data in real-time and modify fiber density, polymer elasticity, and bonding properties dynamically.
   Include real-time AI learning from material stress tests to reinforce weaker structural points and optimize fiber-polymer interactions.
   “A reinforcement learning-based composite strength optimization system that continuously adjusts fiber content and polymer elasticity in response to live stress and deformation analysis, optimizing structural performance dynamically.”
4. AI-Powered Environmental Adaptability for Dynamic Material Formulation
   In addition to predicting environmental impact, AI dynamically modifies polymer blends and additive compositions based on real-world conditions.
   AI should continuously analyze environmental conditions (heat, moisture, microbial exposure) and adjust material properties dynamically.
   AI should modify stabilizers and plasticizers to optimize material lifespan based on climate, industry, or application needs.
   “An AI-powered self-learning system that modifies polymer composition and additive blends in response to environmental degradation simulations, ensuring optimal material performance across diverse applications.”
5. AI-Driven Material Selection & Customization
   In addition to providing a good breakdown of composite materials (rice husk+biodegradable polymer+additives), AI dynamically selects and optimizes these materials for different applications.
   AI should automate polymer selection (PLA, PBS, PHA) based on application durability and degradation needs.
   AI should dynamically adjust fiber content and plasticizers to optimize flexibility, rigidity, or biodegradability based on real-world usage requirements.
   “An AI-assisted composite formulation system that dynamically selects and adjusts biodegradable polymer blends, fiber content, and additive compositions in response to application-specific mechanical, environmental, and degradation performance criteria.”
6. AI-Controlled Material Composition Adjustments
   AI dynamically adjusts material composition for different applications (automotive, medical, packaging, furniture, electronics, household storage, appliances, office supplies, children's products, and fashion accessories).
7. AI's Real-Time Control Over Production Stages
   AI actively fine-tunes blending, heating, and shaping in real-time based on sensor feedback.

The following are the applications in various industries:
1. Medical & Pharmaceutical Packaging:
   Biodegradable eye drops bottles, sterile trays, medicine containers, pill containers, injection vials, diagnostic kits and blister packaging (pills, tablets, single-dose medications).
   Expanded medical packaging applications: biodegradable liquid medicine bottles, injection vials, and oral suspension containers. AI optimizes sterility, moisture resistance, and controlled degradation for pharmaceutical applications.
2. Furniture & Interior Manufacturing:
   Chairs, tables, cupboards, wardrobes, panels, wall trims. AI optimizes load-bearing strength and durability.
3. Medical & Electronics Casings:
   TVs, radios, smart home devices, clocks, laptop covers, remote controls, circuit board enclosures. AI optimizes heat resistance & structural integrity.
4. Household & Storage Solutions:
   Biodegradable storage bins, kitchen racks, compostable trash cans, eco-friendly waste bins. AI optimizes water resistance & recyclability.
5. Automotive Applications:
   Dashboards, door panels, biodegradable floor mats, car seat backings, seat belt components, crash-resistant panels, and airbags. AI optimizes impact resistance & temperature stability.
6. Packaging & Consumer Goods:
   Biodegradable food-grade containers, compostable cutlery, beverage bottles, shampoo bottles, lotion bottles, and cosmetic containers. AI optimizes packaging strength & shelf-life stability.
   Biodegradable liquid containers: water bottles, shampoo bottles, lotion bottles, and cosmetic packaging. AI optimizes material strength, flexibility, and shelf-life stability while ensuring sustainable disposal.
7. 3D Printing Applications:
   Biodegradable molds for mass manufacturing, prosthetics, and custom consumer products. AI modifies extrusion parameters & defect corrections in real-time.
8. Home Appliances: Refrigerators & Air Conditioners:
   Casings, storage compartments, airflow vents, and internal mounting structures. AI optimizes thermal stability & material durability.
   Electrical Switches & Power Controls: Wall switches, dimmers, power outlets, smart home switch panels. AI optimizes heat resistance & electrical insulation.
   Cupboards & Storage Units: Kitchen cabinets, wardrobes, filing systems. AI optimizes load-bearing strength & moisture resistance.
   Stationery & Office Supplies: Biodegradable pens, notebooks, file folders, desk organizers. AI optimizes flexibility, durability, and recyclability.
   Bathroom & Water Storage Products: Biodegradable faucets, water tanks, showerheads, toilet seats, bathroom organizers. AI optimizes water resistance & hygiene.
   Doors & Home Construction: Biodegradable doors, door frames, sliding panels. AI optimizes structural integrity & insulation.
   Kids' Toys & Learning Materials: Biodegradable building blocks, dolls, educational kits, ride-on toys. AI optimizes safety, flexibility, and biodegradability.
   Hangers & Storage Accessories: Biodegradable clothes hangers, shoe racks, closet storage solutions. AI optimizes material flexibility & weight-bearing capacity.
   Fashion Industry & Wearable Products: Biodegradable spectacle frames, sunglasses, watch casings, shoe soles, buttons, and jewelry. AI optimizes material flexibility, durability, and recyclability.

The following are the summary of the key features:
1. AI should actively adjust biodegradability properties instead of just predicting them.
2. AI should dynamically modify 3D printing and molding processes to correct defects in real-time.
3. AI should continuously optimize material strength based on real-world stress testing.
4. AI should modify polymer blends dynamically based on environmental conditions.
5. AI should automate polymer selection and adjust formulations for different applications.
   The method and system disclosed herein ensures that our AI-driven system is an active decision-maker, not just a monitoring tool. It may expand the scope of AI-enhanced material formulation and adaptability. Further, it may ensure industrial scalability across multiple applications (automotive, medical, packaging, electronics, etc.).

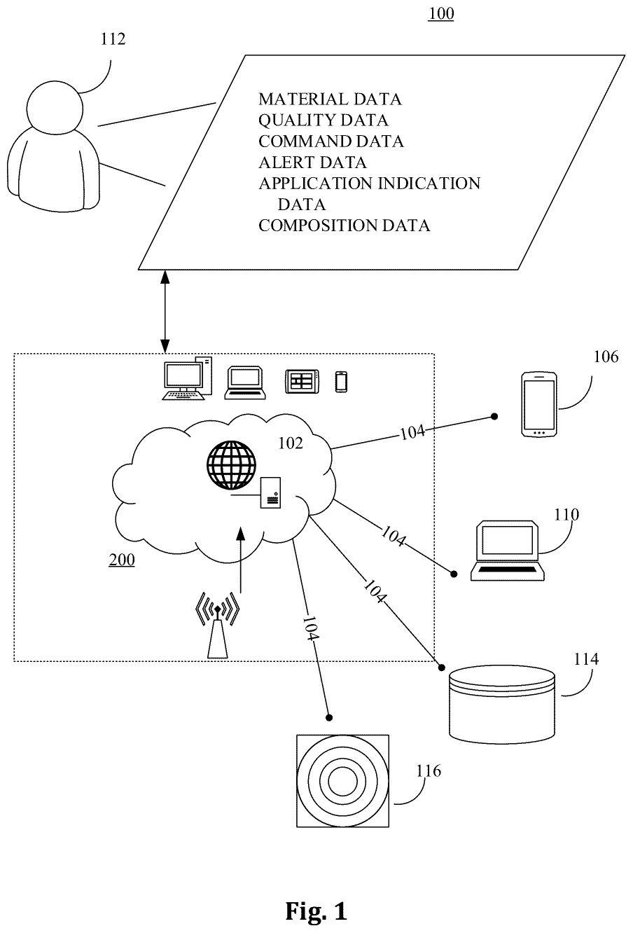

FIG. 1 is an illustration of an online platform 100 consistent with various embodiments of the present disclosure. By way of non-limiting example, the online platform 100 may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 200.

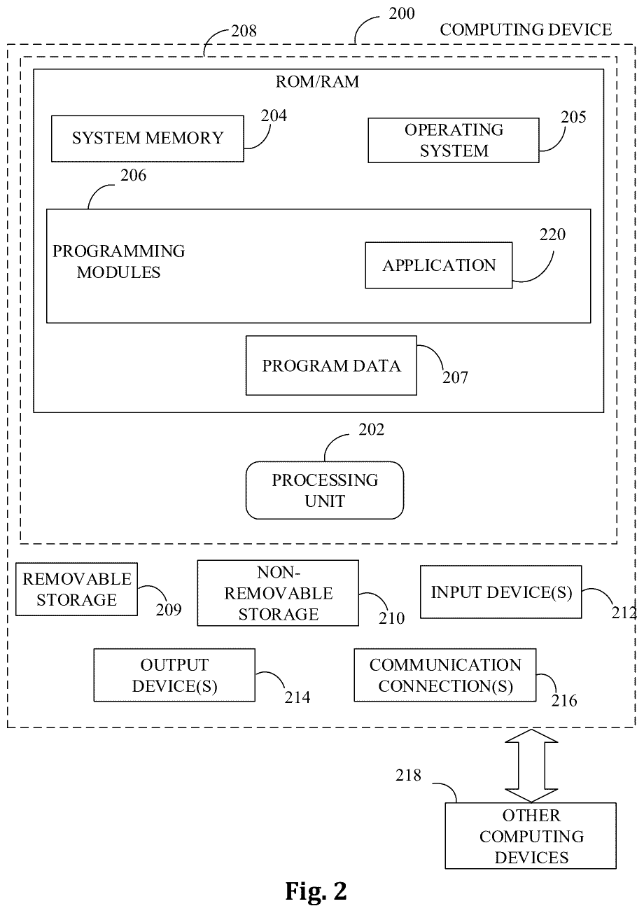

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g. random-access memory (RAM)), non-volatile (e.g. read-only memory (ROM)), flash memory, or any combination. System memory 204 may include operating system 205, one or more programming modules 206, and may include a program data 207. Operating system 205, for example, may be suitable for controlling computing device 200's operation. In one embodiment, programming modules 206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

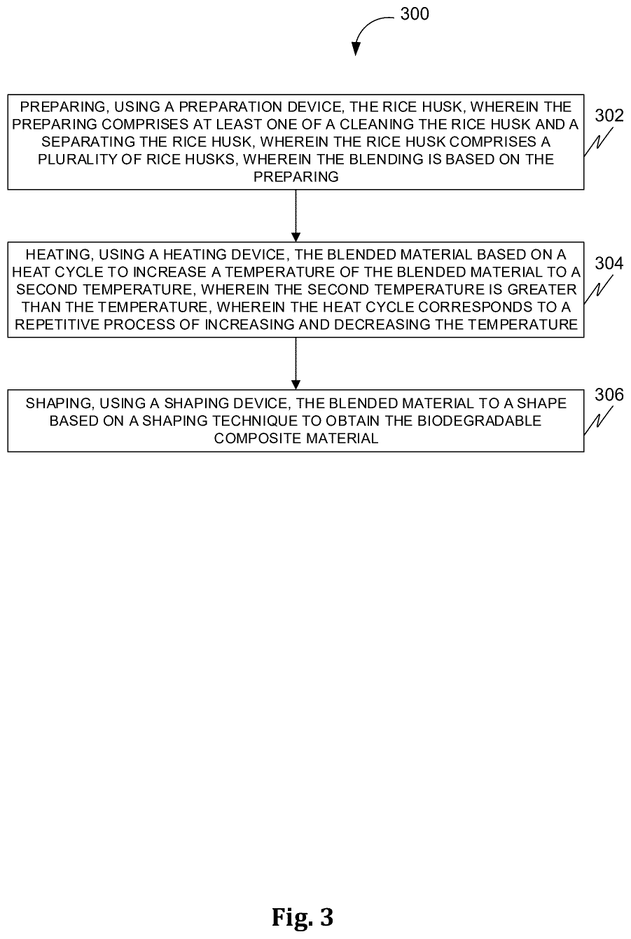

FIG. 3 illustrates a flowchart of a method 300 of manufacturing a biodegradable composite material including shaping, using a shaping device, the blended material to a shape, in accordance with some embodiments.

Accordingly, the method of manufacturing a biodegradable composite material may include a step of blending, using a blending device, a rice husk with a biodegradable polymer in a particular range of a weight percentage to form a blended material. Further, the weight percentage of the rice husk may be in a range of a thirty percentage to a fifty percentage. Further, the weight percentage of the biodegradable polymer may be in a range of a fifty percentage to a seventy percentage.

Further, in some embodiments, the method 300 further may include a step 302 of preparing, using a preparation device, the rice husk. Further, the preparing includes one or more of a cleaning the rice husk and a separating the rice husk. Further, the rice husk includes two or more rice husks. Further, the blending may be based on the preparing. Further, in some embodiments, the method 300 further may include a step 304 of heating, using a heating device, the blended material based on a heat cycle to increase a temperature of the blended material to a second temperature. Further, the second temperature may be greater than the temperature. Further, the heat cycle corresponds to a repetitive process of increasing and decreasing the temperature. Further, in some embodiments, the method 300 further may include a step 306 of shaping, using a shaping device, the blended material to a shape based on a shaping technique to obtain the biodegradable composite material.

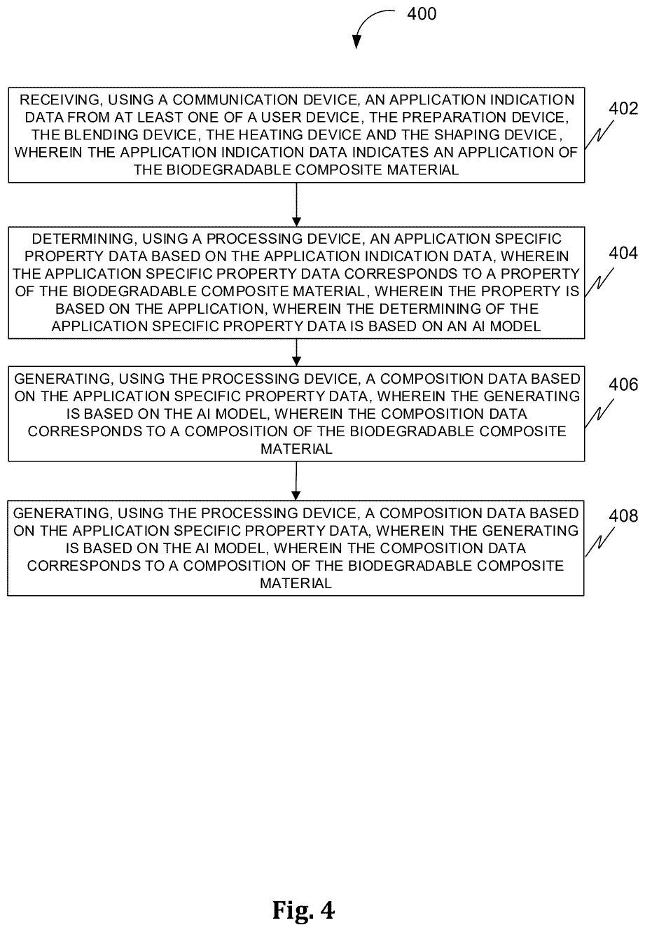

FIG. 4 illustrates a flowchart of a method 400 of manufacturing a biodegradable composite material including generating, using the processing device 1004, a command data, in accordance with some embodiments.

Further, in some embodiments, the method 400 further may include a step 402 of receiving, using a communication device 1002, an application indication data from one or more of a user device, the preparation device, the blending device, the heating device and the shaping device. Further, the application indication data indicates an application of the biodegradable composite material. Further, in some embodiments, the method 400 further may include a step 404 of determining, using a processing device 1004, an application specific property data based on the application indication data. Further, the application specific property data corresponds to a property of the biodegradable composite material. Further, the property is based on the application. Further, the determining of the application specific property data may be based on an AI model. Further, in some embodiments, the method 400 further may include a step of generating, using the processing device 1004, a composition data based on the application specific property data. Further, the generating may be further based on the AI model. Further, the composition data corresponds to a composition of the biodegradable composite material. Further, in some embodiments, the method 400 further may include a step 408 of transmitting, using the communication device 1002, the composition data to one or more of the preparation device, the blending device, the heating device and the shaping device. Further, each of the preparation device, the blending device, the heating device and the shaping device may be configured to execute one or more of the preparing, the blending, the heating and the shaping based on the composition data.

In some embodiments, the composition data represents the weight percentage.

In some embodiments, the application corresponds to one or more of an automotive, a medical, a packaging, a furniture, an electronics, a household storage, an appliance, a fashion accessory, an office supplies and a children's product.

In some embodiments, the application indication data further represents an industry of the application.

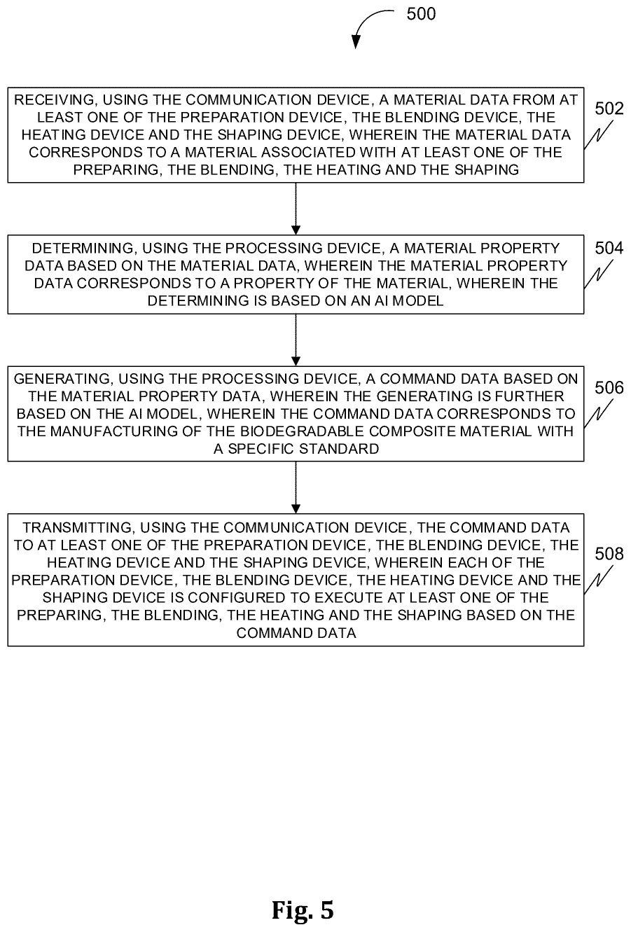

FIG. 5 illustrates a flowchart of a method 500 of manufacturing a biodegradable composite material including generating, using the processing device 1004, a command data, in accordance with some embodiments.

Further, in some embodiments, the method 500 further may include a step 502 of receiving, using a communication device 1002, a material data from one or more of the preparation device, the blending device, the heating device and the shaping device. Further, the material data corresponds to a material associated with one or more of the preparing, the blending, the heating and the shaping. Further, in some embodiments, the method 500 further may include a step 504 of determining, using a processing device 1004, a material property data based on the material data. Further, the material property data corresponds to a property of the material. Further, the determining may be based on an AI model. Further, in some embodiments, the method 500 further may include a step 506 of generating, using the processing device 1004, a command data based on the material property data. Further, the generating may be further based on the AI model. Further, the command data corresponds to the manufacturing of the biodegradable composite material with a specific standard. Further, in some embodiments, the method 500 further may include a step 508 of transmitting, using the communication device 1002, the command data to one or more of the preparation device, the blending device, the heating device and the shaping device. Further, each of the preparation device, the blending device, the heating device and the shaping device may be configured to execute one or more of the preparing, the blending, the heating and the shaping based on the command data.

Further, the method 500 may include a step 510 of analyzing, using the processing device, the material property data with the application specific property data. Further, the analyzing is based on the AI model. Further, the generating of the command data is based on the analyzing.

In some embodiments, the analyzing includes identifying a deviation in the property of the material. Further, one or more of the preparing, the blending, the heating and the shaping based on the command data rectifies the deviation.

In some embodiments, the command data fine-tunes the one or more of the preparing, the blending, the heating and the shaping.

In some embodiments, the blended material includes an additive material.

In some embodiments, the command data corresponds to a parameter corresponding to one or more of the preparing, the blending, the heating and the shaping.

In some embodiments, the AI model is configured to adjust a parameter of one or more of the preparing, the blending, the heating and the shaping based on the material property data.

In some embodiments, the blending includes an adaptive polymer blending. Further, the property of the blended material is adjustable based on the parameters of one or more of the heating and the shaping.

In some embodiments, one or more of the biodegradable polymer and the additive material may be based on the application.

In some embodiments, the material data represents a defect in the material. Further, the command data corresponds to a parameter required to rectify the defect.

In some embodiments, the parameter corresponds to one or more of an extrusion speed, a temperature and a cooling rate.

In some embodiments, the defect is detected by a sensor device. Further, one or more of the preparation device, the blending device, the heating device and the shaping device includes the sensor device.

In some embodiments, the shaping device includes an injection molding. Further, the defect corresponds to shrinkage of the material.

In some embodiments, the material data corresponds to a mechanical strength of the material. Further the command data corresponds to modifying a parameter corresponding to the mechanical strength.

In some embodiments, the parameter corresponds to one or more of a fiber density and a polymer elasticity.

In some embodiments, the parameter corresponds to a bonding property of the material.

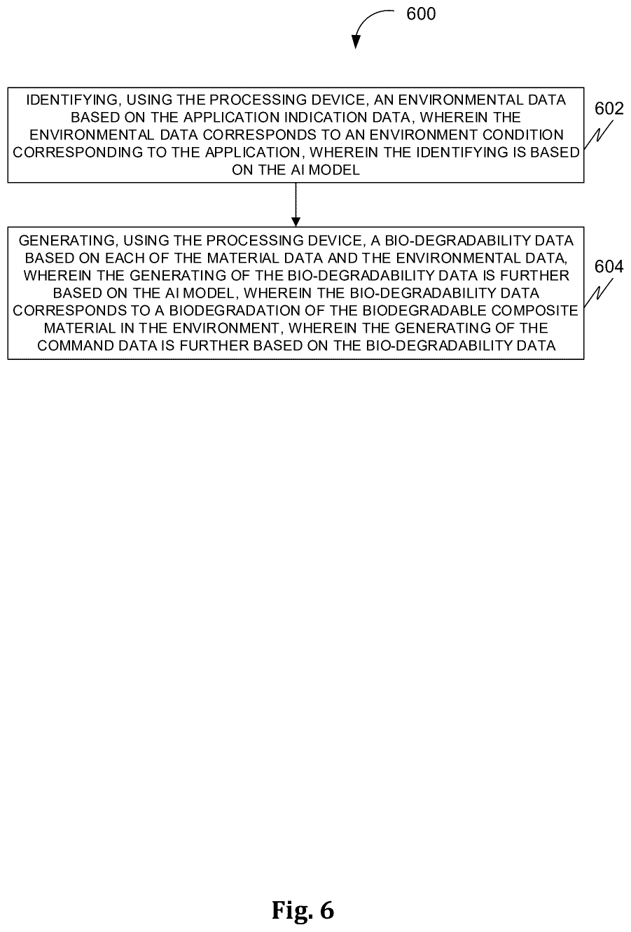

FIG. 6 illustrates a flowchart of a method 600 of manufacturing a biodegradable composite material including generating, using the processing device 1004, a biodegradability data, in accordance with some embodiments.

Further, in some embodiments, the method 600 further may include a step 602 of identifying, using the processing device 1004, an environmental data based on the application indication data. Further, the environmental data corresponds to an environment condition corresponding to an application. Further, the identifying is based on the AI model Further, in some embodiments, the method 600 further may include a step 604 of generating, using the processing device 1004, a biodegradability data based on each of the material data and the environmental data. Further, the generating of the biodegradability data may be further based on the AI model. Further, the biodegradability data corresponds to a biodegradation of the biodegradable composite material in the environment. Further, the generating of the command data may be further based on the biodegradability data.

Further, in some embodiments, the method 600 may include a step 606 of determining, using the processing device 1004, a recyclability data based on the composition data. Further, the recyclability data comprises a recyclability property of the biodegradable composite material for waste management. Further, the generating of the recyclability data is based on the AI model. Further, the generating of the command data may be further based on the recyclability data.

In some embodiments, the command data correspond to a composition of the biodegradable composite material.

In some embodiments, the command data corresponds to one or more of an additive content in the biodegradable composite material and a crosslinking of polymer in the biodegradable composite material.

In some embodiments, the command data corresponds to one or more of a plasticizer in the biodegradable composite material, a bio char level of the biodegradable composite material and a stabilizer in the biodegradable composite material.

In some embodiments, the environmental condition corresponds to one or more of a heat of the environment, a moisture in the environment and a microbial exposure.

In some embodiments, the command data corresponds to a polymer selection based on the biodegradation.

In some embodiments, the method 500 may further include generating, using the processing device 1004, an alert data based on the material data. Further, the alert data includes an alert corresponding to an issue. Further, one or more of the preparation device, the blending device, the heating device and the shaping device may be associated with the issue. Further, the generating of the alert data may be further based on the AI model. Further, the communication device 1002 may be further configured for transmitting the alert data to one or more of the preparation device, the blending device, the heating device, the shaping device and a user device. Further, the user device may be associated with a user.

In some embodiments, one or more of the preparation device, the blending device, the heating device, the shaping device and a user device may be associated with a presentation device. Further, the presentation device may be configured to present the alert data.

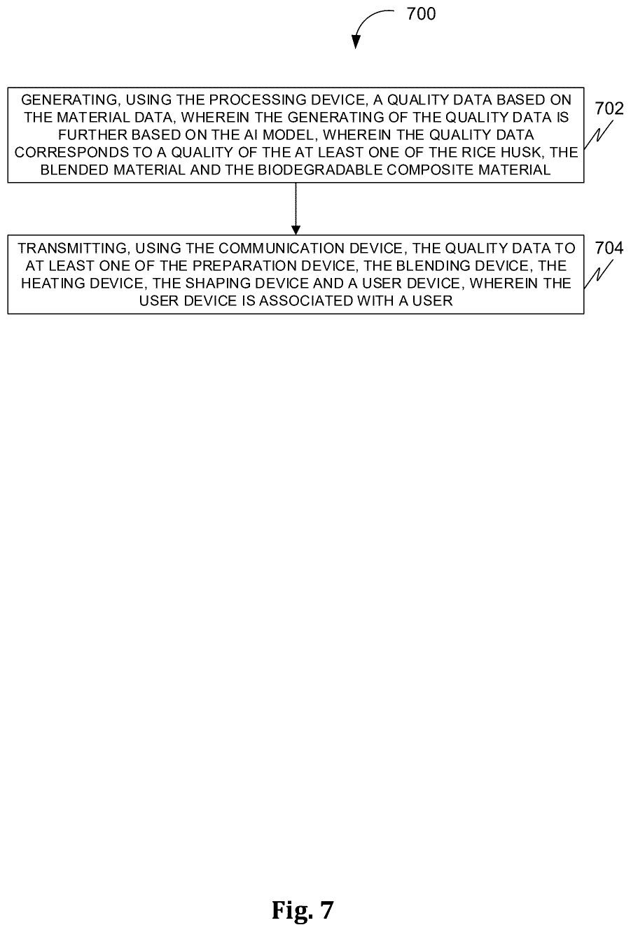

FIG. 7 illustrates a flowchart of a method 700 of manufacturing a biodegradable composite material including generating, using the processing device 1004, a quality data, in accordance with some embodiments.

Further, in some embodiments, the method 700 further may include a step 702 of generating, using the processing device 1004, a quality data based on the material data. Further, the generating of the quality data may be further based on the AI model. Further, the quality data corresponds to a quality of the one or more of the rice husk, the blended material and the biodegradable composite material. Further, in some embodiments, the method 700 further may include a step 704 of transmitting, using the communication device 1002, the quality data to one or more of the preparation device, the blending device, the heating device, the shaping device and a user device. Further, the user device may be associated with a user.

In some embodiments, the one or more of the preparation device, the blending device, the heating device and the shaping device may be associated with a sensor device. Further, the sensor device may be configured to generate the material data based on sensing an environment parameter associated with an environment. Further, the one or more of the preparing, the blending, the heating and the shaping may be associated with an environment.

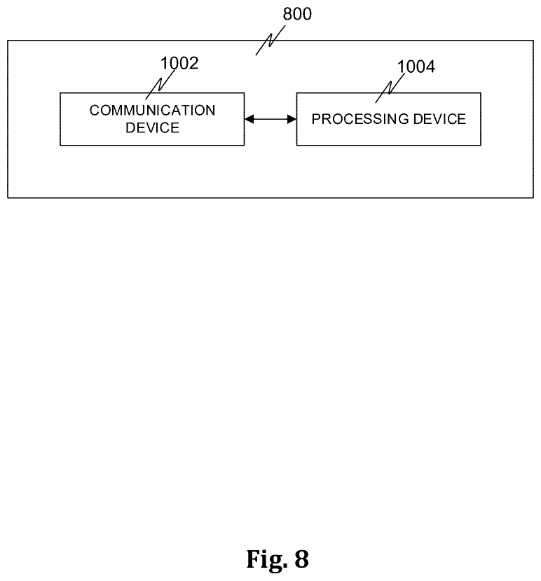

FIG. 8 illustrates a block diagram of a system 800 of manufacturing a biodegradable composite material, in accordance with some embodiments.

Accordingly, the system 800 of manufacturing a biodegradable composite material may a blending device which may be configured for blending a rice husk with a biodegradable polymer in a particular range of a weight percentage to form a blended material. Further, the weight percentage of the rice husk may be in a range of a thirty percentage to a fifty percentage. Further, the weight percentage of the biodegradable polymer may be in a range of a fifty percentage to a seventy percentage.

Further, in some embodiments, the system 800 further may include a preparation device which may be configured for preparing the rice husk. Further, the preparing includes one or more of a cleaning the rice husk and a separating the rice husk. Further, the rice husk includes two or more rice husks. Further, the blending may be based on the preparing. Further, in some embodiments, the system 800 further may include a heating device which may be configured for heating the blended material based on a heat cycle to increase a temperature of the blended material to a second temperature. Further, the second temperature may be greater than the temperature. Further, the heat cycle corresponds to a repetitive process of increasing and decreasing the temperature. Further, in some embodiments, the system 800 further may include a shaping device which may be configured for shaping the blended material to a shape based on a shaping technique to obtain the biodegradable composite material.

Further, in some embodiments, the system 800 further may include a communication device 1002. Further, the communication device 1002 may be configured for receiving an application indication data from one or more of a user device, the preparation device, the blending device, the heating device and the shaping device. Further, the application indication data indicates an application of the biodegradable composite material. Further, the communication device 1002 may be configured for transmitting the composition data to one or more of the preparation device, the blending device, the heating device and the shaping device. Further, each of the preparation device, the blending device, the heating device and the shaping device may be configured to execute one or more of the preparing, the blending, the heating and the shaping based on the composition data. Further, the system 800 further may include a processing device 1004. Further, the processing device 1004 may be configured for determining an application specific property data based on the application indication data. Further, the application specific property data corresponds to a property of the biodegradable composite material. Further, the property is based on the application. Further, the determining of the application specific property data may be based on an AI model. Further, the processing device 1004 may be configured for generating the composition data based on the application specific property data. Further, the generating may be further based on the AI model. Further, the composition data corresponds to a composition of the biodegradable composite material.

Further, in some embodiments, the communication device 1002 may be configured for receiving a material data from one or more of the preparation device, the blending device, the heating device and the shaping device. Further, the material data corresponds to a material associated with one or more of the preparing, the blending, the heating and the shaping. Further, the communication device 1002 may be configured for transmitting a command data to one or more of the preparation device, the blending device, the heating device and the shaping device. Further, each of the preparation device, the blending device, the heating device and the shaping device may be configured to execute one or more of the preparing, the blending, the heating and the shaping based on the command data. Further, the system 800 further may include the processing device 1004. Further, the processing device 1004 may be configured for determining a material property data based on the material data. Further, the material property data corresponds to a property of the material. Further, the determining may be based on an AI model. Further, the processing device 1004 may be configured for generating the command data based on the material property data. Further, the generating may be further based on the AI model. Further, the command data corresponds to the manufacturing of the biodegradable composite material with a specific standard.

Further, in some embodiments, the processing device 1004 may be configured for determining a recyclability data based on the composition data. Further, the recyclability data comprises a recyclability property of the biodegradable composite material for waste management. Further, the generating of the recyclability data may be further based on the AI model. Further, the generating of the command data may be further based on the recyclability data.

In some embodiments, the blended material includes an additive material.

In some embodiments, the biodegradable composite material may be associated with an application. Further, one or more of the biodegradable polymer and the additive material may be based on the application.

In some embodiments, the material data represents a defect in the material. Further, the command data corresponds to a parameter required to rectify the defect.

In some embodiments, the parameter corresponds to one or more of an extrusion speed, a temperature and a cooling rate.

In some embodiments, the material data represents a defect in the material. Further, the command data corresponds to a parameter required to rectify the defect.

In some embodiments, the parameter corresponds to one or more of an extrusion speed, a temperature and a cooling rate.

In some embodiments, the shaping device includes an injection molding. Further, the defect corresponds to shrinkage of the material.

In some embodiments, the material data corresponds to a mechanical strength of the material. Further the command data corresponds to modifying a parameter corresponding to the mechanical strength.

In some embodiments, the parameter corresponds to one or more of a fiber density and a polymer elasticity.

In some embodiments, the parameter corresponds to a bonding property of the material.

Further, in some embodiments, the processing device 1004 may be further configured for identifying an environmental data based on the application indication data. Further, the environmental data corresponds to an environment condition corresponding to an application. Further, the identifying may be based on the AI model. Further, the processing device 1004 may be further configured for generating a biodegradability data based on each of the material data and the environmental data. Further, the generating of the biodegradability data may be further based on the AI model. Further, the biodegradability data corresponds to a biodegradation of the biodegradable composite material in the environment. Further, the generating of the command data may be further based on the biodegradability data.

In some embodiments, the command data correspond to a composition of the biodegradable composite material.

In some embodiments, the command data corresponds to one or more of an additive content in the biodegradable composite material and a crosslinking of polymer in the biodegradable composite material.

In some embodiments, the command data corresponds to one or more of a plasticizer in the biodegradable composite material, a bio char level of the biodegradable composite material and a stabilizer in the biodegradable composite material.

In some embodiments, the environmental condition corresponds to one or more of a heat of the environment, a moisture in the environment and a microbial exposure.

In some embodiments, the command data corresponds to a polymer selection based on the biodegradation.

In some embodiments, the processing device 1004 may be further configured for generating an alert data based on the material data. Further, the alert data includes an alert corresponding to an issue. Further, one or more of the preparation device, the blending device, the heating device and the shaping device may be associated with the issue. Further, the generating of the alert data may be further based on the AI model. Further, the communication device 1002 may be further configured for transmitting the alert data to one or more of the preparation device, the blending device, the heating device, the shaping device and a user device. Further, the user device may be associated with a user.

In some embodiments, one or more of the preparation device, the blending device, the heating device, the shaping device and a user device may be associated with a presentation device. Further, the presentation device may be configured to present the alert data.

In some embodiments, the processing device 1004 may be further configured for generating a quality data based on the material data. Further, the generating of the quality data may be further based on the AI model. Further, the quality data corresponds to a quality of the one or more of the rice husk, the blended material and the biodegradable composite material. Further, the communication device 1002 may be further configured for transmitting the quality data to one or more of the preparation device, the blending device, the heating device, the shaping device and a user device. Further, the user device may be associated with a user.

In some embodiments, the one or more of the preparation device, the blending device, the heating device and the shaping device may be associated with a sensor device. Further, the sensor device may be configured to generate the material data based on sensing an environment parameter associated with an environment. Further, the one or more of the preparing, the blending, the heating and the shaping may be associated with an environment.

In some embodiments, the sensor device includes one or more of an ultrasonic sensor and an optical sensor.

In some embodiments, the additive material corresponds to one or more of a natural fiber, a plasticizer, a binding agent, an ultraviolet stabilizer and an antimicrobial agent.

In some embodiments, the natural fiber corresponds to one or more of a coconut husk, a banana fiber, a kenaf and a flax.

In some embodiments, the plasticizer corresponds to one or more of a glycerol and a soybean oil.

In some embodiments, the binding agent corresponds to one or more of a starch and a plant-based resin.

In some embodiments, the ultraviolet stabilizer corresponds to an outdoor application. Further, the application includes the outdoor application.

In some embodiments, the antimicrobial agent corresponds to a sterile medical application. Further, the application includes the sterile medical application.

In some embodiments, the application includes a high-strength application. Further, the biodegradable polymer corresponds to a polylactic acid. Further, the additive material corresponds to a natural fiber.

In some embodiments, the weight percentage of the polylactic acid corresponds to a sixty percentage. Further, the weight percentage of the rice husk corresponds to a forty percentage.

In some embodiments, the high-strength application corresponds to one or more of an automotive industry and a durable packaging.

In some embodiments, the biodegradable composite material corresponds to one or more of an interior trim, a sound absorbing panel and a fastener.

In some embodiments, the application corresponds to one or more of a flexible product and a disposable product. Further, the biodegradable polymer corresponds to a polybutylene succinate. Further, the additive material corresponds to a glycerol.

In some embodiments, the weight percentage of the polybutylene succinate corresponds to a seventy percentage. Further, the weight percentage of the rice husk corresponds to a thirty percentage.

In some embodiments, one or more of a flexible product and a disposable product corresponds to one or more of a medical device and a single use item.

In some embodiments, the biodegradable composite material corresponds to one or more of a disposable syringe, a dosage cup and a sterile packaging.

In some embodiments, the application includes a soil-compatible agriculture product application. Further, the biodegradable polymer corresponds to a polyhydroxyalkanoate. Further, the additive material corresponds to a bio char.

In some embodiments, the weight percentage of the rice husk corresponds to a fifty percentage. Further, the weight percentage of the polyhydroxyalkanoate corresponds to a fifty percentage.

In some embodiments, the soil-compatible agriculture product application corresponds to one or more of a seedling tray and a mulch film.

In some embodiments, the application includes an enhanced biodegradability application. Further, the biodegradable polymer corresponds to a combination of a polylactic acid and a polybutylene succinate. Further, the additive material corresponds to an algae powder.

In some embodiments, the weight percentage of the combination corresponds to a sixty-five percentage. Further, the weight percentage of the rice husk corresponds to a thirty-five percentage.

In some embodiments, the enhanced biodegradability application corresponds to an eco-friendly packaging.

In some embodiments, the biodegradable composite material corresponds to one or more of a single-use container and an eco-friendly wrap.

In some embodiments, the application includes one or more of a prototyping application and a custom part application. Further, the additive material corresponds to a starch. Further, the biodegradable polymer corresponds to a combination of a polylactic acid and a polyhydroxyalkanoate.

In some embodiments, the weight percentage of the combination corresponds to a sixty percentage. Further, the weight percentage of the rice husk corresponds to a forty percentage.

In some embodiments, the one or more of a prototyping application and a custom part application corresponds to one or more of a three dimensional filaments and a rapid prototype.

In some embodiments, the biodegradable composite material corresponds to one or more of an automotive prototype and a three-dimensional printed medical tool.

In some embodiments, the application corresponds to an electronics. Further, the biodegradable composite material corresponds to one or more of a biodegradable circuit component and a biodegradable casing.

In some embodiments, the application corresponds to one or more of a fashion and an accessory. Further, the biodegradable composite material corresponds to one or more of an eyewear frame, a button and a jewelry.

In some embodiments, the command data corresponds to one or more of the preparing, the blending, the heating and the shaping.

In some embodiments, the material data corresponds to the preparing. Further, the property data corresponds to a moisture content in the rice husk.

In some embodiments, the material data corresponds to the preparing. Further, the property data corresponds to a strength of a fiber in the risk husk.

In some embodiments, the AI model may be based on a neural network.

In some embodiments, the material data corresponds to one or more of an image data, a text data, an audio data and a video data.

In some embodiments, the determining corresponds to a spectroscopic analysis.

In some embodiments, the command data corresponds to a parameter associated with one or more of the preparing, the blending, the heating and the shaping.

In some embodiments, the command data corresponds to the blending. Further, the parameter corresponds to a blending parameter corresponding to one or more of a temperature, a viscosity and a density.

In some embodiments, the command data corresponds to the blending ratio.

In some embodiments, the AI model may be trained on two or more material data.

In some embodiments, the specific standard corresponds to an application-specific standard.

In some embodiments, the environmental condition corresponds to a humidity of the environment and a temperature of the environment.

In some embodiments, the command data corresponds to the heat cycle.

In some embodiments, the AI model may be trained on two or more thermal profiles. Further, the two or more thermal profiles corresponds to a temperature change associated with the manufacturing in relation to time.

In some embodiments, the shaping technique corresponds to one or more of an injection molding, a compression molding and a three-dimensional printing.

In some embodiments, the material data corresponds to the shaping technique corresponding to an injection molding. Further, the command data corresponds to adjusting a parameter corresponding to the injection molding.

In some embodiments, the material property data corresponds to a size of the biodegradable composite material.

In some embodiments, the material data corresponds to the shaping technique corresponding to a three-dimensional printing. Further, the command data corresponds to a speed of an extrusion. Further, the three dimensional printing may be associated with the extrusion.

In some embodiments, the material data corresponds to the shaping technique corresponding to a three-dimensional printing. Further, the command data corresponds to a consistency of a layer. Further, the three-dimensional printing may be associated with a printing of the layer.

In some embodiments, the quality data represents a micro defect in the biodegradable composite material.

In some embodiments, the sensor device includes an image sensor.

In some embodiments, the sensor device includes an ultrasonic sensor.

In some embodiments, the command data corresponds to a formulation of the biodegradable composite material.

In some embodiments, the application includes a medical and pharmaceutical packaging. Further, the biodegradable composite material includes one or more of an eye drop bottle, a sterile tray, a medicine container and a blister packaging of a product.

In some embodiments, the biodegradable composite material includes one or more of a pill container, an injection vial and a diagnostic container.

In some embodiments, the product includes one or more of a pill, a tablet and a single-dose medication.

In some embodiments, the biodegradable composite material includes one or more of a liquid medicine bottle, an injection vial, an oral suspension container.

In some embodiments, each of the application specific property data and the material property data corresponds to one or more of a sterility property, a moisture resistance property, a controlled biodegradation.

In some embodiments, the application corresponds to one or more of a furniture product and an interior product. Further, the biodegradable composite material includes one or more of a chair, a table, a cupboard, a wardrobe, a panel, a wall trim.

In some embodiments, each of the application specific property data and the material property data corresponds to a load bearing strength and a durability.

In some embodiments, the application includes one or more of a medical casing and an electronics casing. Further, the biodegradable composite material includes a casing of one or more of a television, a radio, a smart home device, a clock, a laptop and a remote.

In some embodiments, the biodegradable composite material includes one or more a laptop covers and a circuit board enclosure.

In some embodiments, each of the application specific property data and the material property data corresponds to one or more of a heat resistance and a structural integrity.

In some embodiments, the application includes one or more of a household solution and a storage solution. Further, the biodegradable composite material includes one or more of a biodegradable storage bin, a kitchen rack, a compostable trash can and an eco-friendly waste bin.

In some embodiments, each of the application specific property data and the material property data corresponds to one or more of a water resistance and a recyclability.

In some embodiments, the application includes an automotive application. Further, the biodegradable composite material includes one or more of a dashboard, a door panel, a biodegradable floor mats, a car seat backing, a seat-belt component, a crash-resistance panel and an airbag.

In some embodiments, each of the application specific property data and the material property data corresponds one or more of an impact resistance and a temperature stability.

In some embodiments, the application includes one or more of a packaging and a consumer good.

In some embodiments, the biodegradable composite material includes one or more of a shampoo bottle, a lotion bottle and a cosmetic container.

In some embodiments, the biodegradable composite material includes one or more of a biodegradable food-grade container, a compostable cutlery and a beverage bottle. Further, each of the application specific property data and the material property data corresponds one or more of a packaging strength and a shelf-life stability.

In some embodiments, the biodegradable composite material includes a biodegradable liquid container. Further, the biodegradable liquid container includes one or more of a water bottle, a shampoo bottle, a lotion bottle and a cosmetic packaging.

In some embodiments, each of the application specific property data and the material property data corresponds one or more of a material strength, a flexibility and a shelf life stability.

In some embodiments, the application includes a three dimensional printing application. Further, the biodegradable composite material includes a biodegradable mold for one or more of a mass manufacturing, a prosthetic and a custom customer product.

In some embodiments, each of the application specific property data and the material property data corresponds to an extrusion parameter. Further, the command data rectifies a defect.

In some embodiments, the application includes a home application.

In some embodiments, the application corresponds to one or more of a refrigerator and an air conditioner. Further, the biodegradable composite material includes one or more of a casing, a storage compartment, an airflow vent and an internal mounting structure.

In some embodiments, each of the application specific property data and the material property data corresponds to a thermal stability and a material durability.

In some embodiments, the application corresponds to one or more of an electrical switch and a power control. Further, the biodegradable composite material includes one or more of a wall switch, a dimmer, a power outlet and a smart home switch panel.

In some embodiments, each of the application specific property data and the material property data corresponds to one or more of a heat resistance and an electrical insulation.

In some embodiments, the application corresponds to one or more of a cupboard unit and a storage unit. Further, the biodegradable composite material includes one or more of a kitchen cabinet, a wardrobe and a filling system.

In some embodiments, each of the application specific property data and the material property data corresponds to one or more of a load-bearing strength and a moisture resistance.

In some embodiments, the application corresponds to one or more of a stationery supply and an office supply. Further, the biodegradable composite material includes one or more of a biodegradable pen, a notebook, a file folder and a desk organizer.

In some embodiments, each of the application specific property data and the material property data corresponds to one or more of a flexibility, a durability and a recyclability.

In some embodiments, the application corresponds to one or more of a bathroom product and a water storage product. Further, the biodegradable composite material includes one or more of a biodegradable faucet, a water tank, a showerhead, a toilet seat and a bathroom organizer.

In some embodiments, each of the application specific property data and the material property data corresponds to one or more of a water resistance and a hygiene property.

In some embodiments, the application corresponds to one or more of a door construction and a home construction. Further, the biodegradable composite material includes one or more of a biodegradable door, a door frame and a sliding panel.

In some embodiments, each of the application specific property data and the material property data corresponds to one or more of a structural integrity and an insulating property.

In some embodiments, the application corresponds to one or more of a kid's toy and a learning material. Further, the biodegradable composite material includes one or more of a biodegradable building blocks, a doll, an education kit and a ride-on-toy.

In some embodiments, each of the application specific property data and the material property data corresponds to one or more of a flexibility and a biodegradability.

In some embodiments, the application corresponds to one or more of a hanger and a storage accessory. Further, the biodegradable composite material includes one or more of a biodegradable cloth hanger, a shoe rack and a closet storage solution.

In some embodiments, each of the application specific property data and the material property data corresponds to one or more of a material flexibility and weight bearing capacity.

In some embodiments, the application corresponds to one or more of a fashion industry and a wearable product. Further, the biodegradable composite material includes one or more of a biodegradable spectacle frame, a sunglass, a watch casing, a shoe sole, a button and a jewelry.

In some embodiments, each of the application specific property data and the material property data corresponds to one or more of a material flexibility, a durability and a recyclability. Although the invention has been explained in relation to its preferred embodiment, it is to be understood that many other possible modifications and variations can be made without departing from the spirit and scope of the invention as hereinafter claimed.

1. A method of manufacturing a biodegradable composite material, wherein the method comprising blending, using a blending device, a rice husk with a biodegradable polymer in a particular range of a weight percentage to form a blended material, wherein the weight percentage of the rice husk is in a range of a thirty percentage to a fifty percentage, wherein the weight percentage of the biodegradable polymer is in a range of a fifty percentage to a seventy percentage.

2. The method of claim 1 further comprises:
preparing, using a preparation device, the rice husk, wherein the preparing comprises at least one of a cleaning the rice husk and a separating the rice husk, wherein the rice husk comprises a plurality of rice husks, wherein the blending is based on the preparing;
heating, using a heating device, the blended material based on a heat cycle to increase a temperature of the blended material to a second temperature, wherein the second temperature is greater than the temperature, wherein the heat cycle corresponds to a repetitive process of increasing and decreasing the temperature; and
shaping, using a shaping device, the blended material to a shape based on a shaping technique to obtain the biodegradable composite material.

3. The method of claim 2 further comprises:
receiving, using a communication device, an application indication data from at least one of a user device, the preparation device, the blending device, the heating device and the shaping device, wherein the application indication data indicates an application of the biodegradable composite material;
determining, using a processing device, an application specific property data based on the application indication data, wherein the application specific property data corresponds to a property of the biodegradable composite material, wherein the property is based on the application, wherein the determining of the application specific property data is based on an AI model;
generating, using the processing device, a composition data based on the application specific property data, wherein the generating is based on the AI model, wherein the composition data corresponds to a composition of the biodegradable composite material; and
transmitting, using the communication device, the composition data to at least one of the preparation device, the blending device, the heating device and the shaping device, wherein each of the preparation device, the blending device, the heating device and the shaping device is configured to execute at least one of the preparing, the blending, the heating and the shaping based on the composition data.

4. The method of claim 3 further comprises:
receiving, using the communication device, a material data from at least one of the preparation device, the blending device, the heating device and the shaping device, wherein the material data corresponds to a material associated with at least one of the preparing, the blending, the heating and the shaping;
determining, using the processing device, a material property data based on the material data, wherein the material property data corresponds to a property of the material, wherein the determining is based on an AI model;
generating, using the processing device, a command data based on the material property data, wherein the generating is further based on the AI model, wherein the command data corresponds to the manufacturing of the biodegradable composite material with a specific standard; and
transmitting, using the communication device, the command data to at least one of the preparation device, the blending device, the heating device and the shaping device, wherein each of the preparation device, the blending device, the heating device and the shaping device is configured to execute at least one of the preparing, the blending, the heating and the shaping based on the command data.

5. The method of claim 1, wherein the blended material comprises an additive material

6. The method of claim 3 further comprising:
identifying, using the processing device, an environmental data based on the application indication data, wherein the environmental data corresponds to an environment condition corresponding to the application, wherein the identifying is based on the AI model; and
generating, using the processing device, a biodegradability data based on each of the material data and the environmental data, wherein the generating of the biodegradability data is further based on the AI model, wherein the biodegradability data corresponds to a biodegradation of the biodegradable composite material in the environment, wherein the generating of the command data is further based on the biodegradability data.

7. The method of claim 4 further comprises generating, using the processing device, an alert data based on the material data, wherein the alert data comprises an alert corresponding to an issue, wherein at least one of the preparation device, the blending device, the heating device and the shaping device is associated with the issue, wherein the generating of the alert data is further based on the AI model, wherein the communication device is further configured for transmitting the alert data to at least one of the preparation device, the blending device, the heating device, the shaping device and a user device, wherein the user device is associated with a user.

8. The method of claim 7, wherein at least one of the preparation device, the blending device, the heating device, the shaping device and a user device is associated with a presentation device, wherein the presentation device is configured to present the alert data.

9. The method of claim 4 further comprises:
generating, using the processing device, a quality data based on the material data, wherein the generating of the quality data is further based on the AI model, wherein the quality data corresponds to a quality of the at least one of the rice husk, the blended material and the biodegradable composite material; and
transmitting, using the communication device, the quality data to at least one of the preparation device, the blending device, the heating device, the shaping device and a user device, wherein the user device is associated with a user.

10. The method of claim 3, wherein the at least one of the preparation device, the blending device, the heating device and the shaping device is associated with a sensor device, wherein the sensor device is configured to generate the material data based on sensing an environment parameter associated with an environment, wherein the at least one of the preparing, the blending, the heating and the shaping is associated with an environment.

11. A system for manufacturing a biodegradable composite material, the system comprising a blending device configured for blending a rice husk with a biodegradable polymer in a particular range of a weight percentage to form a blended material, wherein the weight percentage of the rice husk is in a range of a thirty percentage to a fifty percentage, wherein the weight percentage of the biodegradable polymer is in a range of a fifty percentage to a seventy percentage.

12. The system of claim 11 further comprises:
a preparation device configured for preparing the rice husk, wherein the preparing comprises at least one of a cleaning the rice husk and a separating the rice husk, wherein the rice husk comprises a plurality of rice husks, wherein the blending is based on the preparing;
a heating device configured for heating the blended material based on a heat cycle to increase a temperature of the blended material to a second temperature, wherein the second temperature is greater than the temperature, wherein the heat cycle corresponds to a repetitive process of increasing and decreasing the temperature; and
a shaping device configured for shaping the blended material to a shape based on a shaping technique to obtain the biodegradable composite material.

13. The system of claim 12 further comprises:
a communication device configured for:
receiving an application indication data from at least one of a user device, the preparation device, the blending device, the heating device and the shaping device, wherein the application indication data indicates an application of the biodegradable composite material;
transmitting a composition data to at least one of the preparation device, the blending device, the heating device and the shaping device, wherein each of the preparation device, the blending device, the heating device and the shaping device is configured to execute at least one of the preparing, the blending, the heating and the shaping based on the composition data;
a processing device is configured for:
determining an application specific property data based on the application indication data, wherein the application specific property data corresponds to a property of the biodegradable composite material, wherein the property is based on the application, wherein the determining of the application specific property data is based on an AI model; and
generating the composition data based on the application specific property data, wherein the generating is based on the AI model, wherein the composition data corresponds to a composition of the biodegradable composite material.

14. The system of claim 13, wherein the communication device is further configured for:
receiving a material data from at least one of the preparation device, the blending device, the heating device and the shaping device, wherein the material data corresponds to a material associated with at least one of the preparing, the blending, the heating and the shaping;
transmitting a command data to at least one of the preparation device, the blending device, the heating device and the shaping device, wherein each of the preparation device, the blending device, the heating device and the shaping device is configured to execute at least one of the preparing, the blending, the heating and the shaping based on the command data, wherein the processing device is further configured for:
determining a material property data based on the material data, wherein the material property data corresponds to a property of the material, wherein the determining is based on an AI model; and
generating the command data based on the material property data, wherein the generating is further based on the AI model, wherein the command data corresponds to the manufacturing of the biodegradable composite material with a specific standard.

15. The system of claim 11, wherein the blended material comprises an additive material.

16. The system of claim 13, wherein the processing device is further configured for:
identifying an environmental data based on the application indication data, wherein the environmental data corresponds to an environment condition corresponding to the application, wherein the identifying is based on the AI model; and
generating a biodegradability data based on each of the material data and the environmental data, wherein the generating of the biodegradability data is further based on the AI model, wherein the biodegradability data corresponds to a biodegradation of the biodegradable composite material in the environment, wherein the generating of the command data is further based on the biodegradability data.

17. The system of claim 14, wherein the processing device is further configured for generating an alert data based on the material data, wherein the alert data comprises an alert corresponding to an issue, wherein at least one of the preparation device, the blending device, the heating device and the shaping device is associated with the issue, wherein the generating of the alert data is further based on the AI model, wherein the communication device is further configured for transmitting the alert data to at least one of the preparation device, the blending device, the heating device, the shaping device and a user device, wherein the user device is associated with a user.

18. The system of claim 17, wherein at least one of the preparation device, the blending device, the heating device, the shaping device and a user device is associated with a presentation device, wherein the presentation device is configured to present the alert data.

19. The system of claim 14, wherein the processing device is further configured for generating a quality data based on the material data, wherein the generating of the quality data is further based on the AI model, wherein the quality data corresponds to a quality of the at least one of the rice husk, the blended material and the biodegradable composite material, wherein the communication device is further configured for transmitting the quality data to at least one of the preparation device, the blending device, the heating device, the shaping device and a user device, wherein the user device is associated with a user.

20. The system of claim 13, wherein the at least one of the preparation device, the blending device, the heating device and the shaping device is associated with a sensor device, wherein the sensor device is configured to generate the material data based on sensing an environment parameter associated with an environment, wherein the at least one of the preparing, the blending, the heating and the shaping is associated with an environment.
